(19) United States
(12) Patent Application Publication
(10) Pub. No.: US 2019/0325507 A1
(43) Pub. Date: Oct. 24, 2019

(54) Systems and Methods for Customer Engagement in Travel Related Programs

(71) Applicant: International Cruise & Excursion Gallery, Inc., Scottsdale, AZ (US)

(72) Inventors: John Roger Rowley, Scottsdale, AZ (US); Marcia Gene Rowley, Scottsdale, AZ (US); Teddy Floyd Davault, Clarkdale, AZ (US); Kris Singleton, Scottsdale, AZ (US)

(21) Appl. No.: 16/455,478

(22) Filed: Jun. 27, 2019

Related U.S. Application Data
(63) Continuation-in-part of application No. 15/783,935, filed on Oct. 13, 2017.
Application No. 15/783,935 is a continuation-in-part of application No. 14/992,520, filed on Jan. 11, 2016, now abandoned.
Application No. 14/992,520 is a continuation-in-part of application No. PCT/US2015/035042, filed on Jun. 10, 2015.
(60) Provisional application No. 62/089,002, filed on Dec. 8, 2014.

(51) Int. Cl. G06Q 30/06; G06N 20/00; G06N 3/04; G06Q 50/14; H04L 9/06; G06F 17/16

(52) U.S. Cl. CPC G06Q 30/0641; G06N 20/00; G06N 3/04; H04L 2209/38; H04L 9/0637; G06F 17/16; H04L 9/0643; G06Q 50/14

(57) ABSTRACT

A system for processing a travel-related sequence of user interactions includes an operational intelligence engine configured to store the travel-related sequence of user interactions; a reconciliation engine configured to query the operational intelligence engine to determine a set of actions performed in conjunction with the sequence of user interactions; and an audit module configured to receive the set of actions from the reconciliation engine, verify the actions, and store the verified actions in an immutable distributed ledger.

### CROSS-REFERENCE TO RELATED APPLICATIONS

This application claims priority, as a continuation-in-part, to U.S. patent application Ser. No. 15/783,935, filed Oct. 13, 2017 and U.S. patent application Ser. No. 14/992,520, filed Jan. 11, 2016, the entire disclosures of each of which are hereby incorporated herein by reference.

### TECHNICAL FIELD

The present invention relates, generally, to an on-line portal offering travel related products to club members and, in particular, to the application of machine learning techniques and immutable distributed ledgers to the offering of travel related products.

### BACKGROUND

Presently known loyalty programs such as frequent flyer clubs, shopping clubs, credit-card based purchasing incentives, and vacation clubs offer financial benefits to members in return for brand loyalty and engagement. Consumers participate in loyalty programs to accumulate redeemable benefits, and to enjoy lower prices attributable to the volume-based purchasing power of the program participants. In some loyalty programs and vacation clubs, the perception of status and affluence can be an important component of membership privileges. The value of such membership is based on the overall program benefits as well as the prestige associated with being a member of the group.

In addition, travel related web sites purport to offer consumers deep discounts on hotel rooms, merchandise, cruises, and vacations by displaying both a “retail” price and a discounted price for a plurality of similar products. However, to the extent the site's revenue model involves realizing a profit on each transaction, the discounted prices necessarily include a margin above and beyond the site's product acquisition cost. As a result, consumer loyalty remains elusive; that is, consumers typically make travel related purchasing decisions based on price without regard to brand loyalty.

Furthermore, it is not unusual for a consumer to allege that a particular travel-related experience was not consistent with what was promised (e.g., wrong category of hotel room, unavailability of rental vehicle, etc.), which can lead to difficulties with respect to verifying whether the consumer's contractual expectations were fulfilled.

Systems and methods are needed which overcome these and other limitations of existing incentive-based travel and rewards programs.

### SUMMARY OF THE INVENTION

Various embodiments of the present invention provide systems and methods for: i) verifying, via an automated audit module, a sequence of travel-related transactions and storing them using an immutable distributed ledger (“blockchain”); ii) creating and verifying fulfillment of smart contracts and associated sequences of travel-related actions; iii) providing a yield engine that incorporates machine learning techniques configured to algorithmically allocate a portion of the available margin for a transaction to the member to drive future engagement; and iv) providing an intuitive yield engine user interface that allows an administrator to manipulate an intuitive yield matrix which is then mapped to a set of tags and rule-sets used for supervised learning of a yield engine machine learning model. Various other embodiments, aspects, and features are described in greater detail below.

### BRIEF DESCRIPTION OF THE DRAWING FIGURES

The present invention will hereinafter be described in conjunction with the appended drawing figures, wherein like numerals denote like elements, and:

FIG. 1 is a conceptual block diagram of a customer engagement system in accordance with various embodiments;

FIGS. 2A-2B are conceptual block diagrams illustrating, in greater detail, the system of FIG. 1;

FIG. 3 illustrates an immutable distributed ledger implemented in the context of the system illustrated in FIG. 1;

FIG. 4 is a conceptual block diagram illustrating the flow of information to an operation intelligence engine in accordance with various embodiments;

FIG. 5 illustrates a user interface for a yield engine incorporating supervised learning in accordance with various embodiments;

FIG. 6 is a block diagram of the system level architecture of an exemplary yield engine and associated inputs and outputs in accordance with various embodiments;

FIG. 7 is a streamlined flow diagram of the system shown in FIG. 6;

FIG. 8 is block diagram illustrating core functions driven by an exemplary rules engine in accordance with various embodiments;

FIG. 9 is a screen shot of exemplary search results depicting the market rate (FMV), savings credits, and the member preferred rate (MPR) for a plurality of hotel rooms responsive to a search request in accordance with various embodiments;

FIG. 10 is a screen shot of exemplary search results depicting the market rate (FMV) and a subscriber rate for a plurality of hotel rooms responsive to a search request in accordance with various embodiments;

FIG. 11 is a screen shot of an exemplary account summary including a savings component, a certificate component, and a vacation cash component in accordance with various embodiments;

FIG. 12 is a screen shot of a table depicting an exemplary savings credit ledger in accordance with various embodiments;

FIG. 13 is an exemplary table illustrating debits and credits influencing the current lifetime value (CLV) and the future lifetime value (FLV) for a particular member in accordance with various embodiments;

FIG. 14 is an exemplary customer timeline illustrating additional factors influencing FLV for a particular customer (member) in accordance with various embodiments;

FIG. 15 is an exemplary scorecard depicting future lifetime values (FLV) for a particular customer (member) in accordance with various embodiments;

FIG. 16 is a screen shot of a landing page for an exemplary cruise rewards program in accordance with various embodiments; and

FIG. 17 is a screen shot showing exemplary search results within a cruise rewards platform depicting the best nightly rate (FMV) and earned cruise credits for a plurality of hotel rooms responsive to a search request in accordance with various embodiments.

### DETAILED DESCRIPTION OF PREFERRED EXEMPLARY EMBODIMENTS

Various embodiments of the present invention relate to systems and methods for offering travel and lifestyle related products and services to captive consumer bases, typically rewards program members. In accordance with various embodiments, an automated audit system incorporates a distributed immutable ledger (i.e., “blockchain”) to verify and document travel-related transactions and smart contracts utilized in the course of providing such services. In accordance with various embodiments, a yield engine incorporates machine learning techniques and an advanced user interface that allows an administrator to manipulate an intuitive yield matrix that is then mapped to a knowledge base or business process engine comprising a set of tags and rule sets subsequently used in the context of supervised training of a machine learning model.

In general, as described in further detail below, various embodiments are configured to model each club member as a long term asset. Thus, in contrast to traditional travel web sites, the present system does not seek to maximize profit on every transaction. Rather, the present systems and methods seek to promote future engagement with each member, to thereby maximize the lifetime value of each member. In so doing, a portion of the available margin associated with each transaction may be “re-invested” into the customer relationship. That is, short term profitably may be intentionally reduced in order to increase long term profitability.

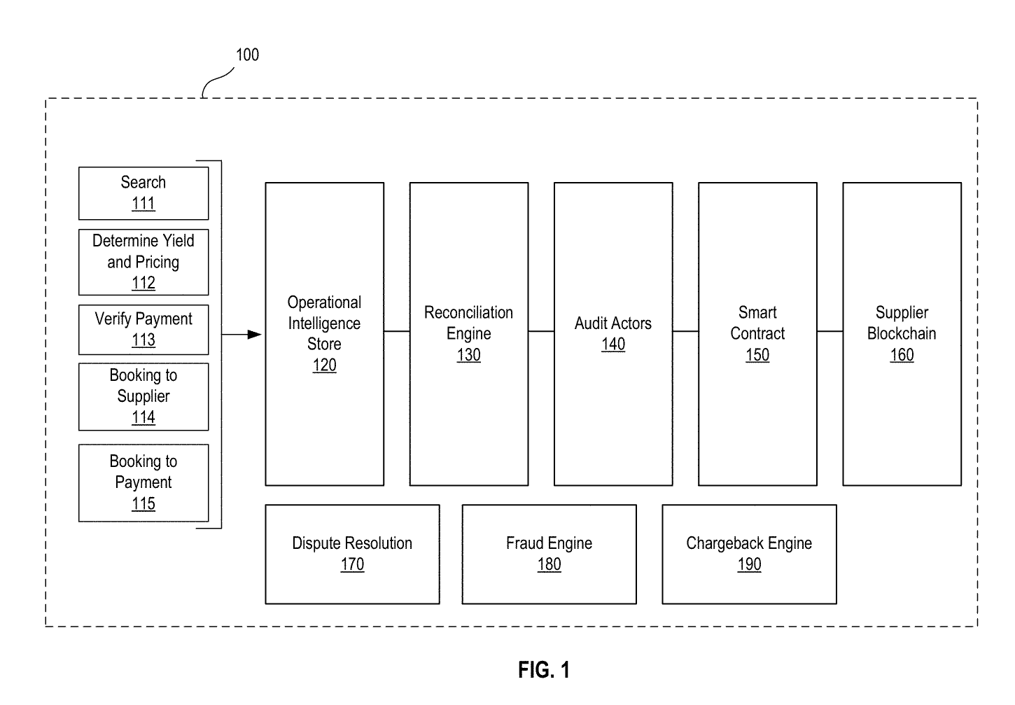

Referring now to FIG. 1, a system for offering travel related products (or simply “system”) 100 generally includes an operational intelligence store 120 that receives multiple inputs relating to a customer's interaction with system 100 including, for example, search inquiries 111 (e.g., a customer web-based search), yield and pricing determinations 112, payment verification 113, a supplier booking 114, and a payment booking 115. System 100 further includes a reconciliation engine or module 130, an audit actor module (or “domain”) 140, a smart contract module 150, and a supplier blockchain module 160. In addition, a dispute resolution module 170, a fraud engine 180, and/or a chargeback engine 190 may be provided in various embodiments.

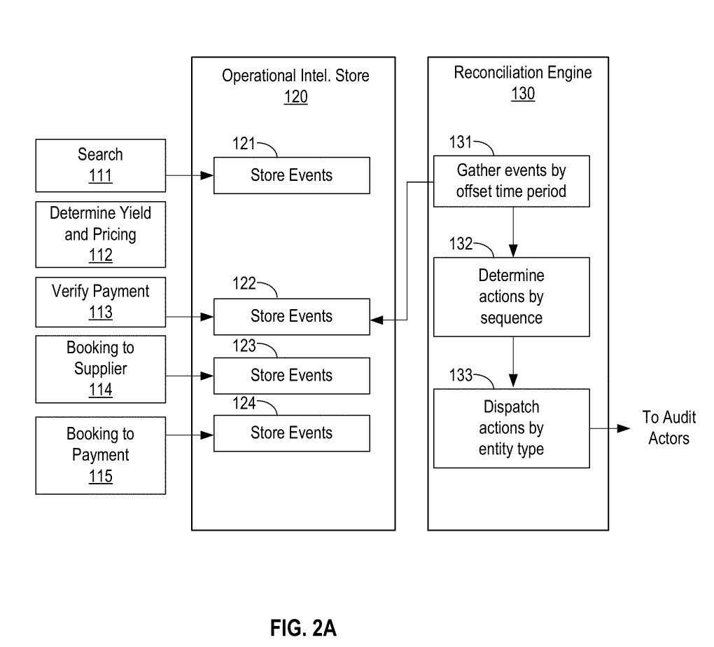

A more detailed view of FIG. 1 and its various functional blocks are illustrated in FIGS. 2A-2B. As shown, operational intelligence engine 120 is configured to store, in a secure manner, various events 121-124 surrounding a travel-related transaction as described above in FIG. 1. In the illustrated embodiment, for example, event 121 relates to search 111, event 122 relates to payment verification 113, event 123 relates to booking-to-supplier 114, and event 124 relates to booking-to-payment 115. It will be understood that any number of events and categories of events may be stored within operational intelligence engine 120, and that the illustrated examples are in no way limiting.

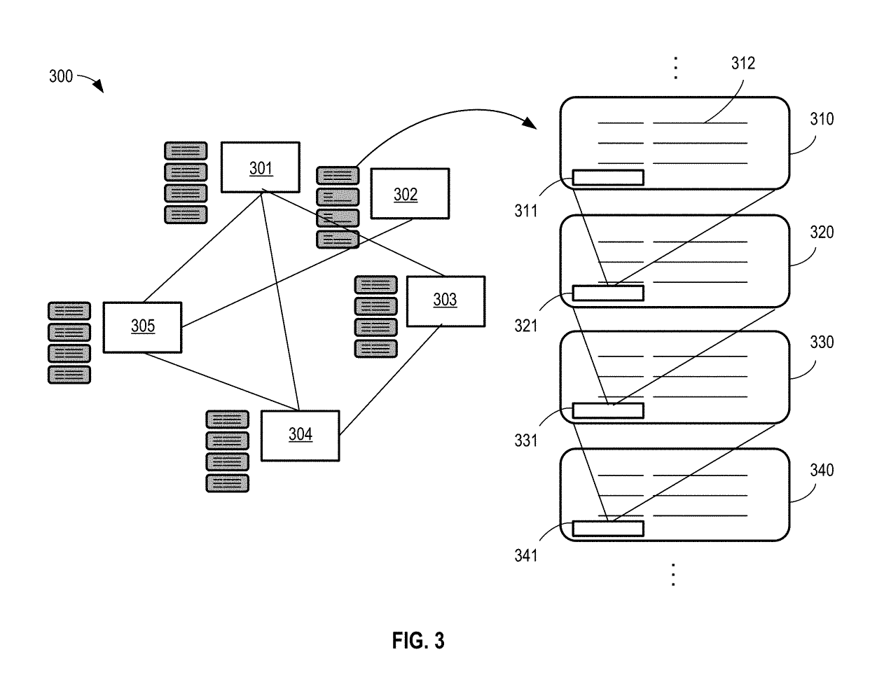

Operational intelligence store 120 may also receive information from one or more external sources. With momentary reference to FIG. 4, for example, the illustrated block diagram depicts the flow of information to an operation intelligence engine 401, which might be implemented within operational intelligence store 120. More particularly, the operation intelligence engine 401 receives information from, for example, a call center 405, online assets 402, mobile devices 403, and one or more suppliers 404.

Referring again to FIG. 2A, reconciliation engine 130 is then configured to search and gather events from operational intelligence store 120 and determine the flow of events relating to one or more transactions. For example, reconciliation engine 130 may determine that a booking occurred, that the system checked for availability, or the like. More particularly, as illustrated in FIG. 2A, reconciliation engine 130 gathers events (e.g., by offset time period) (131), determines the sequence of actions that took place (132), and dispatches, to the audit actors 140, the actions by entity type (133).

Referring to FIG. 2B, audit actors (or audit module) 140 then receive the prior actions and initiates an audit 141. That is, audit module 140 examines the actions that took place (142) and verifies related actions (143). The result of this audit may then be provided to smart contract module 150, which creates (based on information from audit module 140) a smart contract 151. This contract, once fulfilled (153), may be accompanied by an escrow currency 152 and a transfer of such currency 154 as described in detail below. In addition, using an applicable consensus algorithm, a consensus is achieved between audit module 140 (block 144), smart contract module 150 (block 155), and a supplier blockchain 160 (block 161). In this way, the block-chain based system 100 can document that certain events took place (e.g., the user performed a particular search, selected a particular hotel, booked a known room at that hotel, purchased merchandise) and that the system performed as required by the contract.

In addition, the audit module 140 may be configured to “step through” a state machine associated with the desired set of actions, and cure any defects that might be observed. For example, if the customer did not receive a requested receipt for a hotel booking, the system may then send the customer a receipt to fulfill that action. Similarly, if a customer's credit card was authorized but not actually charged for a transaction, the system may retry the charge.

Ultimately, if it is determined that the sequence of actions was performed as required, that information is then stored within one or more blockchains (e.g., within 150, 160) so that it can later be used for confirmation if a dispute arises. In this way the blockchains essentially function as an anticipatory forensic audit, which may be used to resolve future disputes or misunderstandings. If, for some reason, such remediation is unsuccessful, then the system may forward the issue to customer support (e.g., a live human, chat-bot, or the like).

In one embodiment, smart contract module 150 is implemented on a Microsoft Azure Service Fabric platform using, for example, Ethereum Blockchain Logic; alternatively, the smart contract module may be implemented using any one of a variety of permissioned or public blockchain platforms now known or later developed.

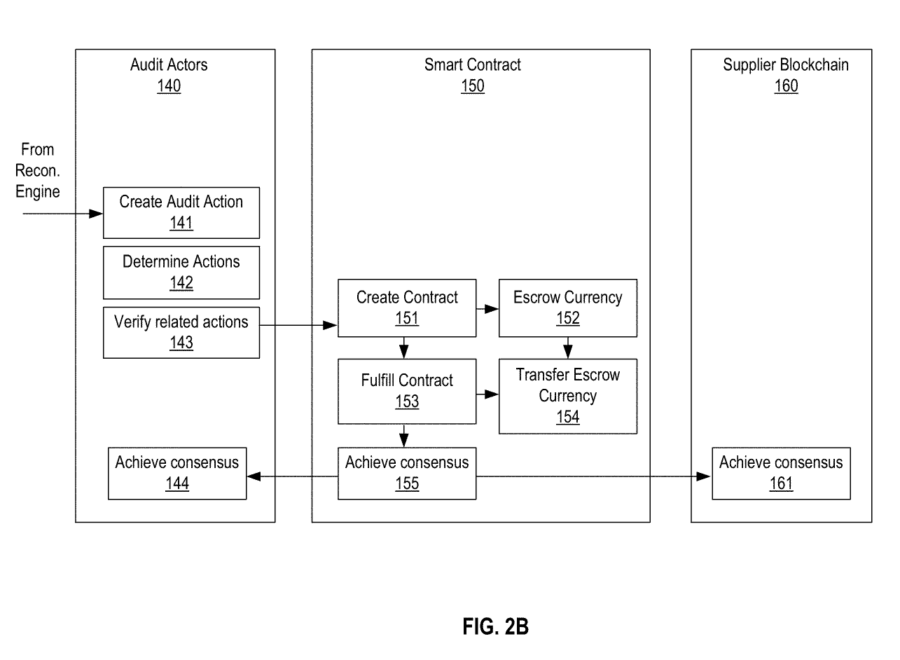

That is, referring momentarily to FIG. 3, smart contract module 150 and/or supplier blockchain 160 may be implemented as a distributed system 300 including multiple entities (e.g., supplier, booking agent, etc.), each of which has its own copy of an immutable ledger as shown—i.e., a series of blocks 310, 320, 330, 340, etc., linked via hashes 311, 321, 331, 341, etc., as is known in the art. Each of the blocks will typically include content 312 associated with the various travel-related transactions described above.

As mentioned briefly above, in accordance with various embodiments a yield engine is equipped with a novel, intuitive user interface that allows an administrator to manipulate an intuitive yield matrix that is then mapped to a set of tags and rule sets configured to output a MPR based on member lifetime value.

As described in further detail below, the present invention employs various techniques to determine a fair market value (FMV) (also referred to herein as market rate or retail rate) for various product categories. The FMV is then compared to the system's fully loaded product acquisition cost to determine the total available margin. A yield engine is then employed to allocate a portion of the available margin back to the member in the form of a discount (using, for example, “burn” currency discussed below), credit (using, for example, “earn” currency discussed below), or other alternative currency. The rules applied during operation of the yield engine are typically difficult to modify in a fast, intuitive manner.

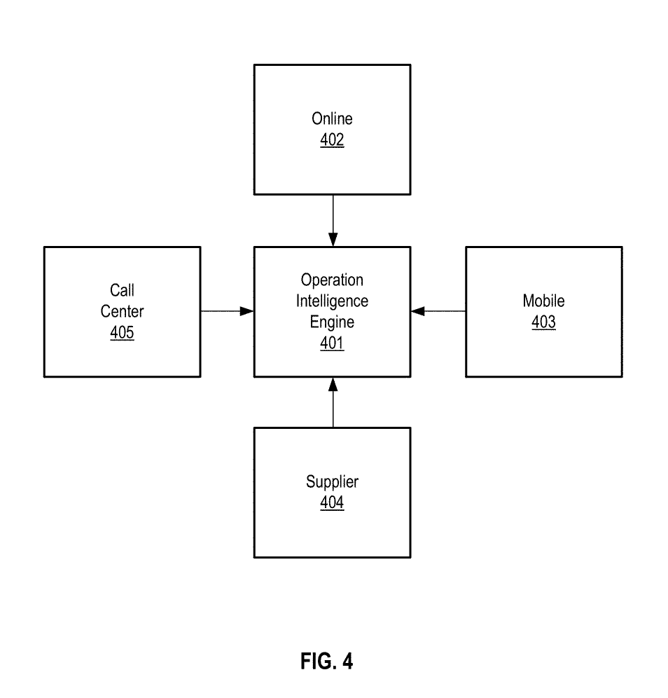

Toward that end, referring now to FIG. 5, an exemplary user interface 500 for a yield engine in accordance with various embodiments generally includes an interactive user interface (e.g., a web interface) partitioned into three major sections: a yield matrix portion 501, a rule set portion 502, and a category tags portion 503.

In general, changes are made to the user interface elements 508 of the matrix portion (i.e., through manual insertion of real or integer values in individual cells), and those changes are transformed into rule sets (504) used to calculate yields and margins in the context of travel related requests and transactions. In this way, supervised learning of a machine learning model is accomplished in order to better predict and monetize customer behavior.

As illustrated, matrix portion 501 includes a rectangular grid 508 in which the column headers correspond to ranges of absolute yield value (e.g., in USD), and the rows correspond to particular yield percentages (e.g., 1%, 2%, etc.). Each of the grid elements is a numerical field that can be dynamically modified by the administrator. The numbers entered into each cell correspond to an index of a rule that has been specified in rule set portion 502. In some embodiments, the administrator is provided the ability, via the user interface, to modify the contents of multiple cells simultaneously (e.g., to change all values of “6” to a value of “60”).

The rule set portion 502 allows the administrator to add rules, save those rules, and observe the results of the rules applied to the relevant data the category tags portion 503 allows selection of particular tags (e.g., margin percent, margin amount, yield) specified by a range of values (range start, range end), which may then be included or excluded as desired (506). As mentioned above, the values entered into the cells of matrix 508 correspond to the rules defined in rule set portion 502.

Stated another way, a yield engine in accordance with various embodiments includes a machine learning model trained via supervised learning and based on an operator-modifiable yield matrix (508) and a corresponding rule set (405). The matrix 508 may be manually changed at any time by an operator with sufficient privileges to do so, and the system will adaptively adjust its learning strategy to accommodate those changes.

In accordance with one embodiment, the individual cells of matrix 508 are color-coded or otherwise coded to indicate “hot spots” of volatility, profitability, yield percent, margin, or the like. This allows an operator to intuitively determine which changes to yield matrix 508 are effective, and which are ineffective over some reference time period. For example, a change calculated to increase short term profitability may be deemed ineffective if it erodes or otherwise negatively impacts booking volume.

The model described above in connection with FIG. 5 may be implemented as one or more machine learning models that undergo supervised, unsupervised, semi-supervised, or reinforcement learning and perform classification (e.g., binary or multiclass classification), regression, clustering, dimensionality reduction, and/or such tasks. Examples of such models include, without limitation, artificial neural networks (ANN) (such as a recurrent neural networks (RNN) and convolutional neural network (CNN), decision tree models (such as classification and regression trees (CART), ensemble t (such as boosting, bootstrapped aggregation, gradient boosting machines, and random forests), Bayesian network models, naive Bayes, principal component analysis (PCA), probabilistic classifiers, support vector machines (SVM), clustering models (such as K-nearest-neighbor, K-means, expectation maximization, hierarchical clustering, etc.), and linear discriminant analysis models.

Having thus given an overview of a yield engine user interface and a blockchain-based auditing process in accordance with various embodiments, a detailed description will now be provided with respect to how such yields and customer valuations may be determined.

In various embodiments, program benefits are introduced which intrinsically add value, but which on an individual transactional basis are difficult to quantify, and may not necessarily be profitable. The system (e.g., system 100 of FIG. 1) therefore tracks each member's unique lifetime value over time (e.g., a multi-year horizon). The system maintains a data fabric (data services) including a ledger of both monetary and non-monetary events for each member, such as membership fees paid, card renewal fees, promotional emails opened (and presumably read), transactions such as purchasing a cruise or a hotel room, membership upgrades, package (bundled) products, transaction upgrades (upgrading a time share or cruise cabin). A current lifetime value (CLV) influenced by monetary transactions and a future lifetime value (FLV) influenced by non-monetary events are fed into a yield engine, which algorithmically allocates a portion of the total available margin for each purchase transaction to the member, for example in the form of credits towards future purchases. While perhaps counterintuitive, re-investing a portion of the available profit margin, the entire margin, or even more than the entire margin, for each transaction back into the customer relationship serves to promote continued customer engagement which, in turn, tends to increase long term profitability; this is particularly true in view of the high costs of customer acquisition.

The present invention employs various techniques to determine a fair market value (FMV) for different product categories. The FMV is then compared to the system's fully loaded cost to acquire the product to determine the total available margin. The yield engine then allocates a portion of the available margin back to the member in the form of a discount, credit, or other alternative currency.

More particularly, the system may be configured to compute an FMV value for a particular hotel room type in real time, recognizing that the FMV can change from moment to moment based on market demand and other economic and social factors. When consumer enters a date and city into a search box on a travel site, the system interrogates a number of predetermined internet sources, and runs the data through an algorithm. Part of the FMV algorithm may involve weighting some sites more heavily than other sites. One objective is to compute an objectively reasonable and verifiable FMV in order to support the system's value proposition to the member. The algorithm used to compute the hotel room FMV may be configured to prioritize first tier sites, and to ignore or give lower weight to second tier sites. In this context, first tier sites may include high traffic, high visibility sites, whereas second tier sites may include sites which the member is not likely to look to for price verification.

As discussed in greater detail below, the system may be configured to dynamically manipulate FMV values for all product categories (e.g., cruise, hotels, merchandise) as needed to support value propositions. For example, some value proposition commitments promise a predetermined savings (e.g., 30%) off FMV. In order to honor these commitments the system may occasionally filter out product options which tend to suppress FMV, and only consider those sites (or assign them greater weight) that support a target FMV. This is consistent with the overriding principle that the FMV must be verifiable and credible, but need not be the lowest price available anywhere on the internet. Seasoned travelers intuitively understand this dynamic.

Once a FMV is determined, the system looks to existing supplier sources to ascertain the acquisition cost for the asset. After receiving a purchase commitment from the member, the system then acquires the asset (e.g., hotel room) from whichever feed provides the lowest acquisition cost, such as a hotel aggregator (e.g., Expedia), or the like. To illustrate, an FMV=$179 and an acquisition cost =$109 represents $70 in available margin the system has to work with for this member for this room purchase (in this example, the available margin represents 39% of FMV). The system then uses the yield engine to determine a member preferred rate (MPR) which, in turn, determines how much of the $70 to share with the member based on, among other factors, that member's current and/or future lifetime economic value to the system, and any applicable partner revenue sharing agreements. Once the consumer commits to the proposed MPR (which is lower than FMV and typically higher than the acquisition cost), the system secures the room from the supplier and directs the consumer to “checkout.”

If the member's then-current lifetime value is low, the system may take a correspondingly higher profit; if the lifetime value is high, the system may take less profit and invest a correspondingly higher amount of the available margin to drive down the effective MPR. The yield algorithm may even suggest incurring an economic loss (e.g., $20) on this particular transaction, for example by allocating $90 to yield an MPR which reflects a significant discount from the FMV, if the algorithm determines that doing so may tend to increase the member's lifetime value by more than $20.

The system employs a more complex variation of the foregoing FMV and margin determination algorithms for use with merchandise. In contrast to the relatively stable and normalized retail price structures of hotel rooms and cruises, manufacturers deeply discount products and allow their distributors to do so in the context of close outs, over buys, and when introducing newer models (or even just new model numbers) of the same or essentially the same product, often at significant losses. The system therefore seeks to avoid using these deeply discounted prices when computing a FMV for merchandise. Again, one goal is to provide the member with a credible retail price—but not necessarily the lowest available—to facilitate a purchase decision.

In connection with merchandise FMVs, the system periodically retrieves price quotes from one or more databases and, in addition, the system may be configured to interrogate web sites or other data repositories in real time (or substantially real time such as every hour, every four hours, or as a new batch of data becomes available). To conserve bandwidth when retrieving data from websites, the system may only retrieve the raw HTML code, sans graphics and other images and CSS elements.

The system may retrieve a large number (e.g., hundreds) of price quotes from different sites, and verify whether a particular retailer is still selling the product at the advertised price, and/or whether this seller is an authorized distributor. The system may assign a confidence/veracity weight to various tier sites (tier 1 may include premier brands such as Macy's, Amazon; tier 2 may include secondary brands such as K-Mart, Walmart, and Ali Baba). The system may employ a price manager module to run a weighted algorithm on the tier 1 and tier 2 sites to arrive at a FMV, perhaps centered around the mode (a cluster of reputable sites advertising the same price). The system may then display that FMV to the consumer; and to reinforce the credibility of the FMV, present a number (e.g., 3-5) of links to reputable sites which support the FMV or a price very close thereto.

In one embodiment the system may use a two tiered rating system that imposes a multiplier (weighted coefficient) based on veracity. Various product web sites may be assigned to confidence levels and are ranked within each level, where Level 1 might include Best Buy and Home Depot; Level 2 may include K-Mart and Macy's; and Level 3 may include reputable local sites, for example. Each site may be ranked differently for different products (e.g., Best buy may be ranked higher for electronics than for appliances). Those skilled in the art will appreciate that ranking product websites within particular levels for purposes of determining FMV may be initially subjective; thereafter, the rankings may be subsequently adjusted based on how often consumers click on a linked site to validate the FMV, which represents an objective indication of member confidence in the veracity of the site.

In this context, first tier sites may also contemplate those sites in which the member is likely to have confidence due to brand loyalty, previous search or purchase history, and/or individual or group affiliated socio-economic factors (e.g., member class, annual income). Second tier sites may include popular or otherwise statistically stable sites, but from which the member is not likely to seek price verification. As a result, the system may compute two different FMVs for the same product (e.g., merchandise, hotel room), based on different member profiles.

Unlike products which have a unique UPC code, air fares identified by flight and seat numbers, and cruises identified by ship names and cabin numbers, there is no objective standard for normalizing hotel rooms. This is due in part to the fact that different hotel room wholesalers often describe the same room in different terms. With approximately 500,000 residential rentals (e.g., AirB&B) and an additional 500,000 hotels (with up to ten or more room types per hotel), the task of standardizing room inventories (collectively “hotel room”) for purposes of determining FMVs is intrinsically subjective and, thus, computationally complex. Currently, the present system can correlate and obtain price points (quotes) from multiple sources for up to 70% or more of the aggregate hotel room inventory. A strategy is needed to correlate the remaining 30% of rooms which resist standardization. The present invention employs adaptive learning of fuzzy logic techniques to recruit the remaining 30% of rooms in order to obtain a more reliable FMV for hotel rooms.

One approach to standardizing non-standardized hotel rooms is to use the popularity of searches by members of different consumer groups for hotel rooms based on, for example, destination city and room type. The most frequently searched metrics are used to manually (or semi-automatically using template tools) assign rooms to one of a plurality of unique “meta-categories” defined by combinations of attributes and amenities such as, for example, non-smoking, view class (ocean, street, garden), newspaper, gym, room size, number of beds, suite, price, kitchenette, free breakfast, in-room bar, floor level (e.g., floors 1-3, 4-10, 11-20, etc.), balcony, bed size, and so on. When a room type is encountered which does not match a then existing meta-category within a master classification matrix, the system may employ one or both of the following techniques: i) use a rule set to search within the complete published description of the room provided by the hotel (i.e., beyond the key words used by the member to search for the room) and assign the room to a category based on the extended description; and ii) revise the master classification matrix to accommodate the combination of features which characterize the mis-matched room. Subsequent rooms having the same or similar characteristics may be assigned to the same meta-category.

In some cases, the same room (or two different rooms having the same combination of features) may be described by different hotel properties in a manner that obscures the “sameness” quality of the two rooms (or two descriptions of the same room). When a suspected match occurs, the system may confirm or refute the sameness hypothesis by comparing one or more identifying metrics of the two rooms (or two descriptions of the same room), including geolocation, address, hotel name, and/or phone number.

Alternatively, apparently disparate rooms may be correlated to the same meta-category if a threshold number (e.g., at least 6 of 20) or a predetermined subset of attributes match. Those rooms that cannot be algorithmically matched to a meta-category may be used to manually revise one or both of the extended search rule set and the meta-category matrix to thereby force a match. That is, the rule set may be augmented with additional terms (e.g., “park view”) to reconcile the short description with the more complete long description of the room; for example, if “microwave” appears in the short description and “refrigerator” appears in the long description, the matching term “kitchenette” may be added to the rule set to reconcile the two apparently disparate descriptions and identify the intrinsic sameness between the two descriptions. In this way, experiential intelligence in the form of machine learning may be incorporated into the rule set, the dynamically reconfigurable meta-category matrix, and/or the implementing algorithms.

The foregoing approach may be recursively applied to mis-matched rooms until substantially all feature combinations are accounted for within the master classification matrix. As new feature combinations are encountered, new meta-categories may be created to classify them. Identifying and quantifying the intrinsic “sameness” among rooms having divergent descriptions in this way allows the system to enhance the reliability and credibility of the resulting FMVs.

Various embodiments contemplate a “B2B2C” model in which the system establishes contractual/economic relationships with a plurality of business partners for the purpose of marketing travel related products and services to captive consumer groups (“members”) associated with each partner. The system is configured to compensate its business partners for the privilege of marketing products and services to each partner's membership. Each business partner may exploit one or more points of entry (or vectors) into the system. Thus, the system employs a club engine configured to simultaneously operate a large number of similarly functioning portals (e.g., web sites). As a result, the club engine permits flexible presentations and swappable combinations for a plurality of uniquely branded sites within a single code base.

The engine dynamically morphs branding, business rules, and alternative (or virtual) currencies for each member and/or member class based on user credentials. In this context, a member class refers to one of a plurality of meta categories to which members may be assigned, where each class has an associated set of rules governing labeling, displays, benefits availability, currencies that can be used, and the like, for all members within that segment. The engine then loads the member's current lifetime value and event history. Based on each member's status and history, the club engine creates a personalized rules set and configures programs, discounts, price points, virtual currencies, payment options, and other attributes of the user experience. The club engine functions as a gateway to the various product engines, as well as a common accounting ledger for the member.

In various embodiments the club engine employs general logic with product specific rules to determine market rates (FMVs) for each partner site operated by the system. For example, hotel APIs may be used to interrogate hotel industry APIs, retrieve rates, and compare and mash them to compute FMVs; whereas merchandise engines may interrogate databases and scrape retail websites in real time to seek pricing information.

The polymorphic behavior of the club engine allows it to simultaneously address multiple product categories from multiple sources based on one or more rules engines, while accessing multiple data servers.

As briefly discussed above and in greater detail below, the system employs a yield engine to compute a member preferred rate (MPR) and thus the profit (or loss) for each transaction, based on a number of variables including a member's current lifetime value (CLV) and future lifetime value (FLV), product acquisition information, and a rules engine which implements partner specific business rules based on previously negotiated partner agreements.

As mentioned previously, the present system does not seek to maximize profit on a per transaction basis. Rather, it seeks to maximize the lifetime value of each member by promoting ongoing engagement. One component of driving member engagement surrounds the notion of sharing the available margin on each transaction with the member, in a manner that incents the member to return to the site for future purchases. Another component involves using individual member preferences in combination with aggregate preference data for the group to which the member belongs to customize marketing efforts directed at the member. In order to measure the effectiveness of these approaches, the system tracks current and future lifetime value metrics for each member using, for example, a theoretical lifetime value derived from a multi-variable algorithm implemented in a data fabric.

For example, each member may be assigned an initial acquisition cost as well as ongoing access costs (e.g., 30% of margin) which are paid to the system partners for the privilege of engaging their members. In this context, partners function as aggregators who bring large groups of captive, high end purchasers to the system.

Just as the yield engine computes the available margin and MPR for each transaction, influenced by CLV and/or FLV, each completed transaction can affect lifetime values going forward. Indeed, some transactions are economically benign (no profit), but can still affect (or not affect) lifetime values. For example, the system may increase future lifetime value based on an observed propensity to buy or spend, such as when a member opens an email or books a flight, even though those events may be revenue neutral. As such, the yield engine plays a key role in influencing lifetime values.

Key lifetime value metrics include: member acquisition costs; marketing costs (e.g., emails, texts, outbound calls, high impact direct mail); transaction margins; positive events such as opening en email and negative events such as not opening an email or otherwise not engaging with the system for a period of time (e.g., six months); a product return, refund, trip cancellation, or negative review; paying a subscription fee; buying a prepaid vacation package; membership renewal; revenue events such as receiving revenue from a customer or from a partner on behalf of a customer; partner revenue sharing expenses; surtaxes; agent sales commissions; product cost; number of transactions, and so on.

In some circumstances members can use accumulated credits to pay some portion of their transactions. For example, paying a $1,000 annual maintenance fee for a time share may result in 1,000 credits in the member's account. The member can use some portion of that credit to reduce the out of pocket cost of a transaction from the FMV to the MPR. In this way the member is incented to engage in future transactions, thereby increasing the member's future lifetime value.

The system seeks to optimize long term revenue for each member through the use of yield management and margin management techniques. In this regard, predictive analytics may be applied to the member's engagement activities to induce the member to upgrade or take other actions to increase lifetime value. For example, a member may be induced to renew or upgrade a membership by allowing the member to use funds from a credit balance based on: i) whether the member previously renewed the membership at least once; ii) the member engaged in at least a predetermined threshold number of transactions during one or more prior years; and/or iii) the nature and value of a recent transaction. Lifetime value information is fed back into the system and used to: i) affect future transactions (e.g., influence future MPR values); and ii) fine tune targeted sales and marketing efforts directed to the member. For example, if the system determines that a member desires a European cruise, the system will avoid pitching a Mexican Riviera cruise. Relevant member preferences may be derived or inferred from emails opened and not opened by the member; a member's search and navigation activities; measured group behavior metrics (tracking customer segmentation, socio-demographic learning and modeling); purchases of rooms from large hotel chains vs independent boutiques; and tendency to open discounted travel offers, while ignoring destination oriented offers. The system may use machine learning to identify, characterize, and weight these and other factors and apply the machine learning to fine tune customized marketing pitches.

By employing member appropriate (relevant to this particular member's preferences) messaging, future engagement and future lifetime value are correspondingly advanced.

For a member selected product, the system determines the fully loaded cost of the product and the retail value (FMV) and, hence, the total available margin. The yield engine algorithmically calculates a member preferred price/value (MPR) which generally corresponds to the amount charged to the member's credit card for the transaction. In a typical use case, the system invites the member to apply membership currency (described below) to reduce the displayed FMV to the displayed MPR, and displays a notice indicating that savings credit has been applied to arrive at “your price” for this transaction.

Existing hotel aggregator sites display a market rate and discount rate for a plurality of rooms. However, the discount rate typically seeks to maximize profit for each transaction. In accordance with the present invention, the yield engine applies membership currency to further discount the FMV down to the MPR, which is usually less than other sites' discount rate because those sites seek to maximize margin on the transaction—whereas in the present invention some of the available margin is re-invested into the member relationship to promote FLV. In an alternate embodiment, if this member does not have sufficient membership currency to reduce the FMV to an attractive MPR, the system displays a notice indicating how much “currency” (and the resulting MPR) the member would enjoy by purchasing a membership upgrade right now.

In yet a further embodiment, the system may use statistical data regarding the effect of pricing on other members' FLVs when determining an MPR for a particular member.

In an embodiment, the system contemplates at least three different types of alternative “currencies”: certificates; burn currency; and earn currency. More particularly, a member may log into a member portal and navigate to a “my account” page which summarizes the member's available balances (primarily based on previous transactions), including savings credits, redeemable certificates, and vacation cash a/k/a “my cash” (or funded currency). In this regard, both vacation cash and savings credit balances may comprise one or both of earn and burn currencies. Some algorithmically-determined (by the yield engine) portion of the savings credit can be used to further reduce the previously calculated MPR price. The savings credit (burn currency) is typically funded with memberships, upgrades, renewals, promotions, and the like. Each membership account includes a detailed savings credit ledger, listing the debits and credits applied to the account. The savings credits do not match the debits/credits dollar for dollar; that is, a $100 subscription renewal may result in a $150 credit.

On the other hand, vacation cash (typically earn currency) is considered to be a margin funded currency, funded through previously paid FMV transactions where the difference between FMV and MPR (the available margin) is stored as future earn currency.

Certificates are typically used by a member to obtain a baseline product, such as a “free” seven day cruise for two people. Often a member will elect to pay additional money to upgrade at the time of redemption, for example from an inner to an outer cabin. As such, the system may be configured to factor the average additional yield (attributable to the upgrade) into the base certificate “buying power.” Cruise lines are willing to provide certificates at deeply discounted rates because members tend to spend more on food, alcohol and entertainment (e.g., gaming) than customers who pay retail.

Although many cruise lines have recognition programs, they typically are not true cruise rewards programs. This is in part attributable to the fact that a typical cruiser purchases a cruise on average every 3.5 years. Moreover, cruise lines are not well equipped to compete with travel sites to offer hotels, merchandise, and non-cruise related vacation packages. Cruise lines therefore have difficulty maintaining engagement with their customers between cruises. The present invention offers a meaningful cruise rewards program, which leverages the fact that consumers who cruise also tend to spend money on: restaurants; resorts; hotels; everyday items; tours; on-line shopping; and wine. By incenting members to use margin dollars stored as vacation credits when purchasing their next cruise, the time between cruises can be reduced. Moreover, by maintaining ongoing contact with the cruise program member, their next cruise will more likely be selected from the cruise supplier's inventory. This may be facilitated by using the margins associated with normal purchasing behavior to motivate members to purchase a cruise earlier in their regular cruise cycle.

Specifically, once a new cruise rewards program member registers with the system, subsequent purchases at hotels, restaurants, tours, and other non-cruise purchases made through a portal associated with the system result in available margins, a portion of which may be stored in a savings account to be applied to the member's next cruise.

In one embodiment, the margin dollars resulting from non-cruise purchases may be used to fund a stored value credit card, which can be used dollar for dollar on the cruise ship, and/or to pay for the cruise itself. The system employs the aforementioned FMV algorithms and yield engine (described in detail below) to determine the available margins for non-cruise purchases, and uses real dollars (paid by the consumer at each transaction rather than discounting the FMV) to defray the net out of pocket cost for the next cruise, while respecting the cruise line's retail price structure.

To underscore the benefits associated with non-cruise related purchases, the system shows cash going into the savings account in real time. For example, instead of indicating that “you saved $200 on this hotel stay,” the system displays a notice to the effect that “we added another $200 to your cruise savings account.”

All transactions on the cruise rewards program site may earn points towards the next cruise, or may be used to pay for merchandise, rental cars, wine, golf, airfare, so long as the purchase is transacted using the cruise rewards program site. For example, a member can pay a $30 FMV price for a bottle of wine rather than a $16 MPR, and store some portion of the available margin (14 points in this example) for later use. One of the keys to this type of “earn” model is that instead of applying a portion of the available margin to reduce FMV to MPR as discussed above, the available margin dollars are paid by the member at each purchase and stored as earned points (e.g., Vacation Cash) on the site for future use. That is, the member actually pays FMV (i.e., retail) or close to it, and the margin is stored as “savings” points or credits. Alternatively, the system can apply the savings account to the member's on board spend bill (the folio) at the end of the cruise (as opposed to applying it to the cost of the cruise itself).

Significantly, the earned vacation cash is considered funded which means that the member can use it to reduce the out of pocket cost for non-cruise purchases even lower than MPR; indeed, the earned points can be used to reduce the FMV all the way down to taxes and fees. Of course that presumes that the member's available vacation cash exceeds the total available margin for the transaction.

In an alternative embodiment of a cruise rewards program, instead of earning margin dollars in advance, the member can pay the full retail price (e.g., FMV) for the cruise. When the member pays their folio account at the end of the cruise, the system funds an amount equal to or in the range of the folio into a savings account which can then be used to pay down some of the margins for future purchases of hotels, meals, wine, and merchandise using the portal; that is, the member can reduce the price from FMV down to somewhere near the wholesale cost for these items, funded by the previously paid folio. This motivates the consumer to upsell on subsequent purchases, because the member can use previously allocated credits to pay some of the incremental cost of future transactions.

As used herein, the term Business Rules broadly contemplates any number of program or partner idiosyncrasies and nuances. By way of non-limiting illustrative example, a particular partner portal may prefer that the system not sell hotel rooms offered by that partner to members who own time shares at one of that partner's properties, because it may tend to undersell their own program. Other rules may require a 14 day advance purchase, or prohibit same day bookings. Other rules may require pricing to be displayed as total stay, nightly stay, tax inclusive/exclusive, or that no king size beds be made available to smokers. Vacation Club partners may want to offer hotels to its members, but not offer competitor hotels to its members. Accordingly, the system identifies various metrics associated with each member (e.g., married/single, property owner, income level, citizenship), and superimposes business rules onto the member metrics. Moreover, business rules are based on inferences and preferences learned over time, and are thus subject to change over time.

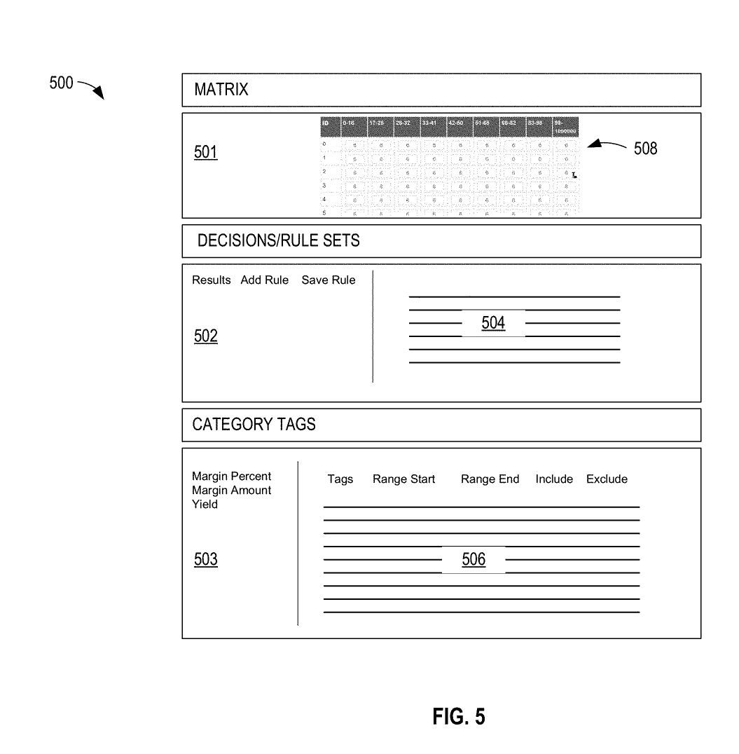

Referring now to FIG. 6, an exemplary yield engine system level architecture 600 useful in the context of FIG. 1 generally includes a member portal 602, a search and product selection module 604, a fair market value (FMV) module 606, a product acquisition cost module 608, and an available margin module 610. The system 600 further includes an overhead cost module 612, a transactional cost module 614, a business rules module 620, a transaction history module 624, a positive activity module 626, a negative activity module 628, and a current and future lifetime value module 622. The foregoing inputs are applied to a yield engine 630, which executes one or more algorithms to output a member preferred price/value 632.

Member portal 602 may be any one of a number of member entry vectors, including interactive web sites implemented on a handheld mobile device such as a smartphone, laptop computer, or the like. Upon accessing a travel site operated by the aforementioned club engine (or a stand-alone platform), the member may navigate through various categories and select a desired cruise, airline, train, bus, marine, or other mode of transportation, rental car, resort, time share, merchandise, vacation, wine, clothing, concert, sports, or other entertainment event, tour, or other activity, product, service, or transaction. In a preferred embodiment, the member must first register with the site in order to be eligible to access its features, as the site is typically only available to members, and is not otherwise available to the general public.

Once the member selects a desired product or service, the FMV module 606 determines a FMV for the product, and optionally displays one or more links to other sites to allow the member to verify the credibility and veracity of the FMV. The product acquisition cost module 608 computes the net cost to the system to acquire the product, for example by interrogating a plurality of sources to retrieve the best wholesale price available at the current time for the selected product in the context of existing supplier relationships. In an embodiment, the system dynamically calls out to vendors (suppliers) with whom the system has negotiated predetermined pricing schedules. In this regard, supplier costs for the same product can vary significantly due to, for example, market dynamics and/or previously negotiated discounts/pricing schedules. For example, a product (e.g., room, flight) purchased on September 1 for travel October 1 may reflect a different cost than the same October 1 travel product purchased on September 2; similarly, a product purchased on September 1 for travel October 1 may reflect a different cost than the same product purchased on September 1.

Based on the FMV and the net cost, the available margin module determines a gross margin 611 for the product. It remains to determine what portion of the available margin should optimally be allocated as system profit, and what portion should optimally be re-invested into the member relationship to induce future engagement and, ultimately, maximize the future lifetime value of the member. Various embodiments also contemplate re-investing an amount equal to or even greater than the available margin into the member relationship to further subsidize the transaction if warranted by a lifetime value analysis, for example if the member has a cruise certificate or credits which will likely result in a future upgrade upon redemption.

Before or concurrently with calculating a member preferred rate (MPR) for the transaction, the system determines the fully loaded cost of the product considering both hard and soft overhead costs. In particular, the overhead cost module 612 accounts for operating expenses including merchant fees (e.g., credit card processing fees), labor, commissions, insurance, regulatory, administrative, and marketing costs, and the like. The transactional cost module 614 accounts for partner expenses such as revenue sharing arrangements and other transaction related costs and fees. The expenses associated with modules 612 and 614 are deducted from the gross margin 611 to yield a net available margin, but the outputs of modules 612, 614 are shown separately applied to the yield calculator 630 inasmuch as they may be a function of the MPR value (e.g., a 3% processing fee).

Although preferred embodiments may be discussed in terms of a single FMV and a single MPR to enhance clarity, those skilled in the art will appreciate that typical use cases involve determining separate (though not necessarily unique) FMV and MPR values and associated gross and net margins for a plurality of products responsive to a member search request.

With continued reference to FIG. 6, the business rules engine 620 applies appropriate business rules to the yield engine and, as discussed below, may even supersede the MPR output by the yield engine. Finally, one or both of the member's current and future lifetime values 622 are applied to the yield engine, where the lifetime values are informed by the member's monetary transaction history 624 and non-monetary event history 626, 628. Although not illustrated in FIG. 6, it will be appreciated that once the transaction is completed (or otherwise terminated), information regarding the transaction may be reflected in the member's current and/or future lifetime value determinations.

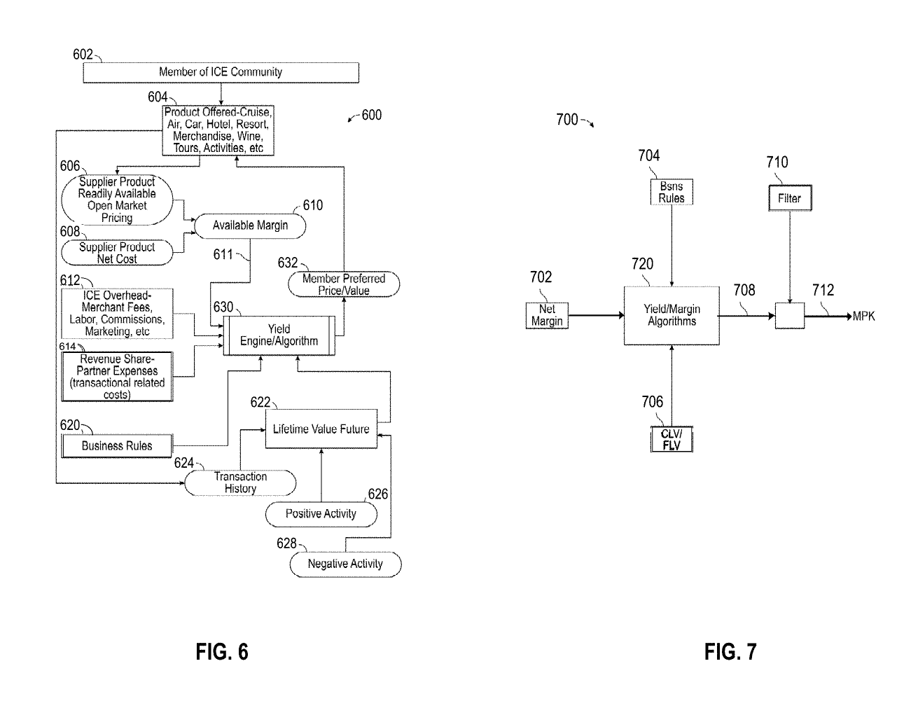

In particular and with momentary reference to FIG. 7, a streamlined flow architecture 700 depicts a net available margin module 702, a rules engine 704, and a lifetime value module 706 applying corresponding signals to a yield/margin calculator 720 configured to output a plurality of search results 708 which, in turn, are filtered and prioritized by a filter module 710 to produce one or more MPR values 712 corresponding to one or more product options available for final selection by the member. It will be appreciated that the member's alternative currencies which may available to reduce the FMV to the MPR are embodied in the CLV and FLV parameters, as implemented by the business rules.

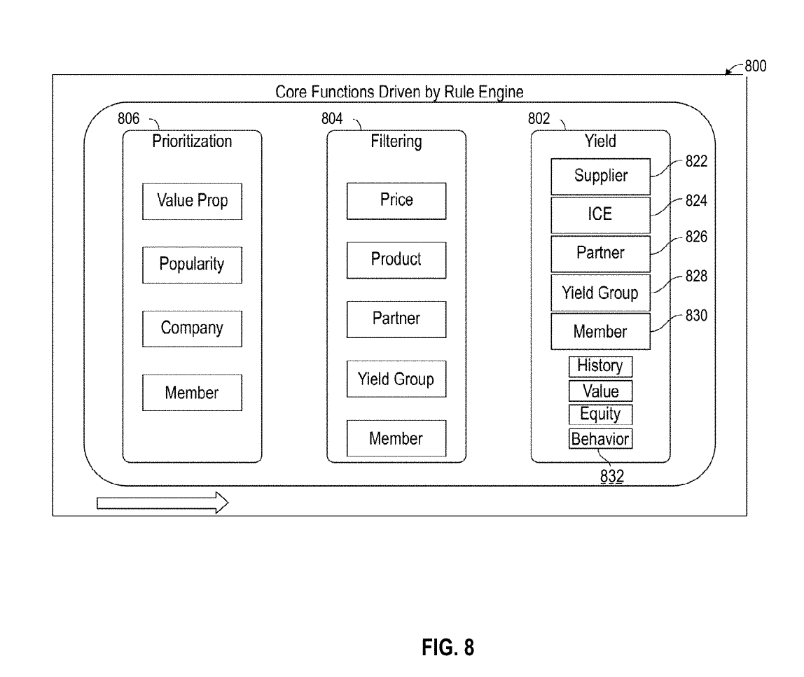

FIG. 8 illustrates various functions Boo implemented by an exemplary rules engine, and includes a yield module 802, a filter module 804, and a prioritization module 806. More particularly, the foregoing description of the yield engine and its various inputs generally corresponds to the yield module 802, wherein the supplier parameter 822 relates to the net supplier costs; the ICE parameter 824 relates to the overhead costs including merchant fees; the partner parameter 826 relates to the transactional costs including revenue sharing and partner expenses; the yield group parameter 828 relates to the system's ability to use information for the member's demographic group until it develops a profile for this particular member; member parameter 830 relates to lifetime value factors 832 including CLV metrics (transaction history, value, and equity) and FLV metrics (behavior such as opening emails and responding to marketing pitches).

With continued reference to FIG. 8, the filtering module 804 and the prioritization module 806 implement the business rules. The filtering module may determine, inter alia, what products and prices or price ranges the system is allowed to display for a particular partner; that is, a partner may have defined minimum or maximum values, or defined certain product sources that are particularly compatible or incompatible with the partner's preferences for its members.

The Yield Group function allows the system to substitute the member's demographic group profile until it learns enough information about this particular member. For example, the system may use a profile associated with the group that the member originated from, or the system may assign the member to a temporary yield group based on where the member lives, or some combination of factors including the member's age, marital status, and/or estimated income based on tracked purchases and/or queries. That is, the system may use a suitable stable profile until a member specific profile can be organically derived.

The Member function considers various member classes, such as Government employee, particular program affiliations, and at a more macro level allows the system to kick in and override a particular MPR, if appropriate. Alternatively, the system can determine an MPR based on a yield group, and then make a decision to adjust it based on factors including this member's CLV and/or FLV.

The prioritization module refers to the order in which the search results are displayed, considering such factors as geo-targeting, as well as group and individual member demographics and metrics. The company parameter suggests that properties owned or controlled by a particular brand should be listed first.

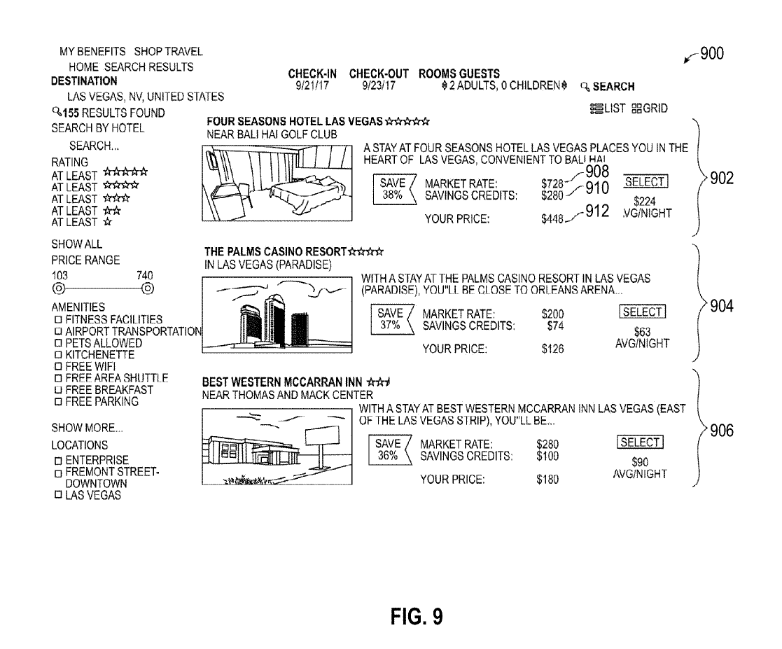

FIG. 9 is a screen shot 900 illustrating exemplary search results including available hotel room profiles 902, 904, and 906, each depicting a market rate (FMV) 908, putatively applied savings credits 910, and a resulting member preferred rate (MPR) 912.

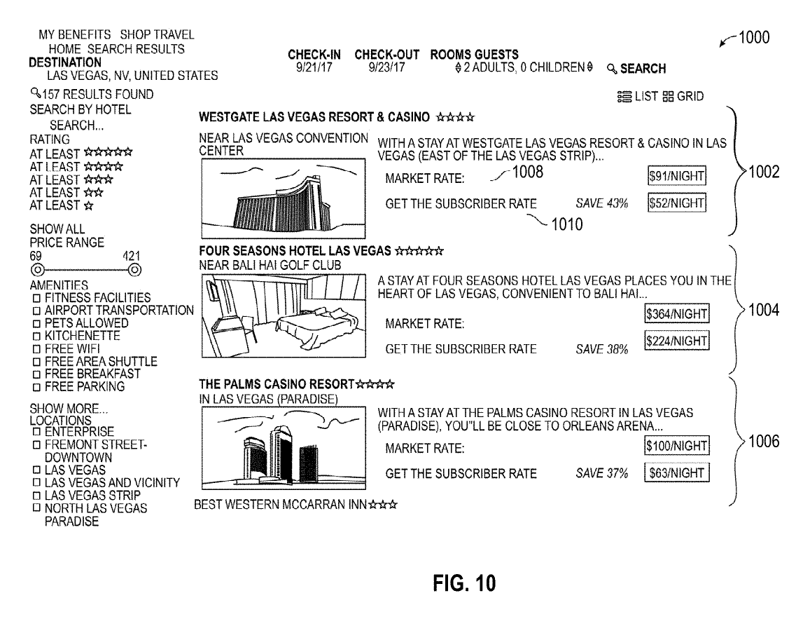

In contrast to FIG. 9, FIG. 10 is a screen shot 1000 illustrating exemplary search results including available hotel room profiles 1002, 1004, and 1006, each depicting a market rate (FMV) 1008 and a proposed subscriber rate 1010 to which the member would be entitled if the member were to purchase a membership upgrade as part of the current transaction.

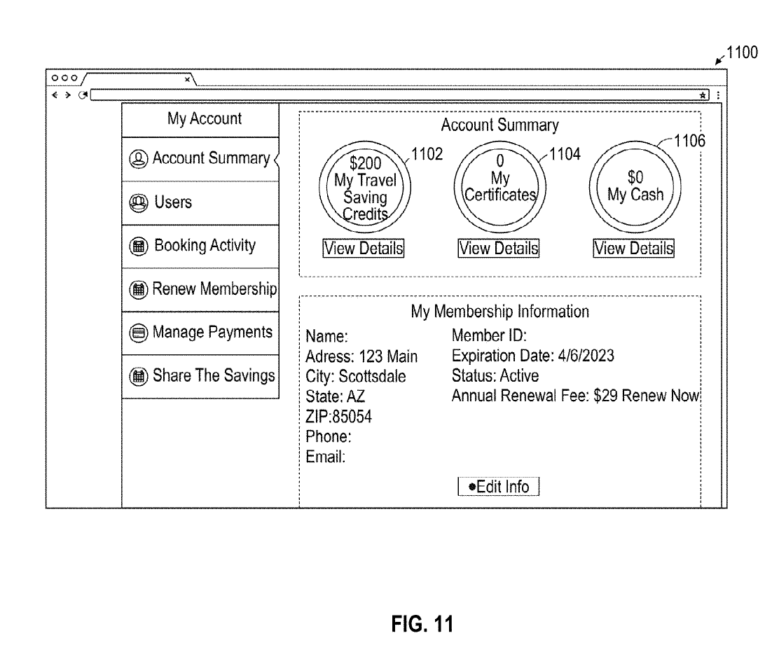

FIG. 11 is a screen shot of an exemplary account summary page 1100 illustrating various alternative currencies including a savings component 1102, a certificate component 1104, and a vacation cash component 1106.

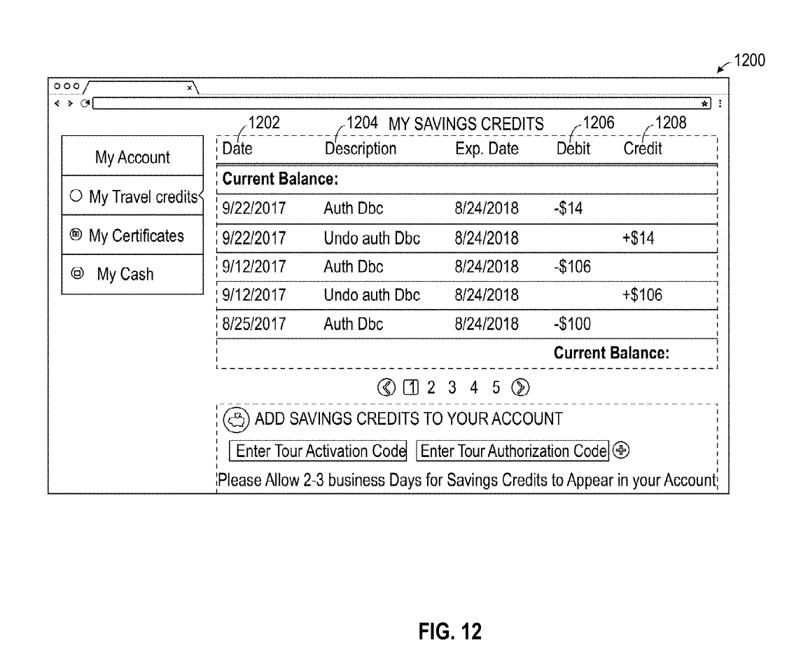

FIG. 12 is a screen shot of an exemplary table 1200 representing a savings credit ledger including a transaction date column 1202, a description column 1204, a debit column 1206, and a credit column 1208. The savings credit summary is generally analogous to the current lifetime value of a member in that it tracks monetary events. The savings credit balance can be used to reduce the FMV down to the MPR for a transaction, subject to limitations imposed by the business rules. For example, in some embodiments the business rules limit the amount of savings credit (also referred to as “earn” credits) that can be used on a particular transaction inasmuch as the savings credits are regarded as margin funded credits. As such, the vacation cash may generally be used to buy down the FMV even below the MPR.

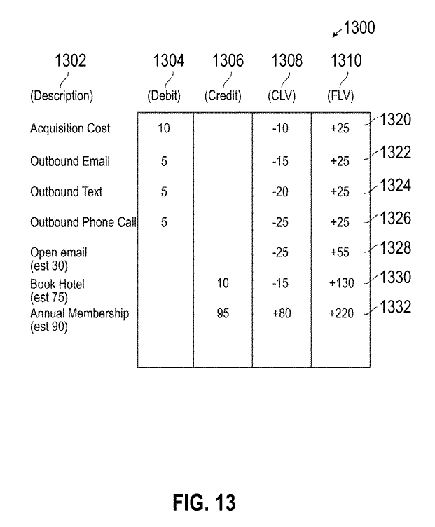

FIG. 13 is an exemplary running ledger illustrating debits and credits associated with the current lifetime value (CLV) and the future lifetime value (FLV) for a particular member. More particularly, the table 1300 includes a description column 1302, a debit column 1304, a credit column 1306, a current lifetime value (CLV) column 1308, and a future or forecast lifetime value (FLV) column 1310. This ledger may be stored, for example, in supplier blockchain 160 of FIGS. 1 and 2.

A first entry 1320 involves the acquisition cost for the member, estimated to be $10 based, for example, on the aggregate cost of acquiring the group divided by the number of group members. Based on the monetary value of the acquisition cost, a corresponding $10 debit is entered into the debit column resulting in a −$10 CLV. However, the system values the opportunity for future revenue resulting from the acquisition of this member at $25 and, accordingly, an initial FLV of $25 is assigned to this member. Based on this member's future purchasing patterns, as well as the purchasing patterns of other members of this same group, the initial FLV assigned to subsequent members from this same group may be adjusted upwardly or downwardly, as appropriate to reflect actual experiential values.

A second entry 1322 relates to a marketing email sent by the system to the member. Based on the cost associated with preparing and sending the email, a corresponding $5 debit is entered into the debit column, further reducing the CLV to −$15(−10−5=−15). The system determined that the sending of the email does not affect this member's FLV, which remains at $25.

A third entry 1324 relates to a marketing text sent by the system to the member. Based on the cost associated with preparing and sending the text, a corresponding $5 debit is entered into the debit column, further reducing the CLV to −$20 (−15−5=−20). The system determined that the sending of the text does not impact this member's FLV, which remains at $25.

A fourth entry 1326 relates to an outbound phone call placed by the system to the member. Based on the cost associated with placing the call, a corresponding $5 debit is entered into the debit column, further reducing the CLV to −$25(−20−5=−25). The system determined that the sending of the text does not impact this member's FLV, which remains at $25.

A fifth entry 1328 relates to the member opening an email (or text) previously received from the system. Since opening the email does not involve a credit or debit, the member's CLV remains at $25. However, the system values the opportunity for additional future revenue resulting from the member opening the email at $30 and, accordingly, $30 is added to the FLV column resulting in a new current FLV of $55 (25+30=55).

With continued reference to FIG. 13, a sixth entry 1330 relates to the member purchasing a hotel room resulting in a $10 net profit flowing to the system. Accordingly, $10 is added to the credit column resulting in a new CLV of −$15(−25+10=−15). In addition, the system determined that the opportunity for additional future revenue resulting from this booking is valued at $75 and, accordingly, $75 is added to the FLV column resulting in a new current FLV of $130 (55+75=130).

A seventh entry 1332 relates to the member purchasing or renewing a membership resulting in a $95 net profit flowing to the system.

Accordingly, $95 is added to the credit column resulting in a new CLV of $80 (−15+95=80). In addition, the system valued that the opportunity for additional future revenue resulting from this payment at $90 and, accordingly, $90 is added to the FLV column resulting in a new current FLV of $220 (130+90=220).

It will be appreciated that the foregoing description of entries is meant to be illustrative, and that any number of events and associated values could be employed to illustrate the manner in which monetary and non-monetary events impact CLV and FLV valuations.

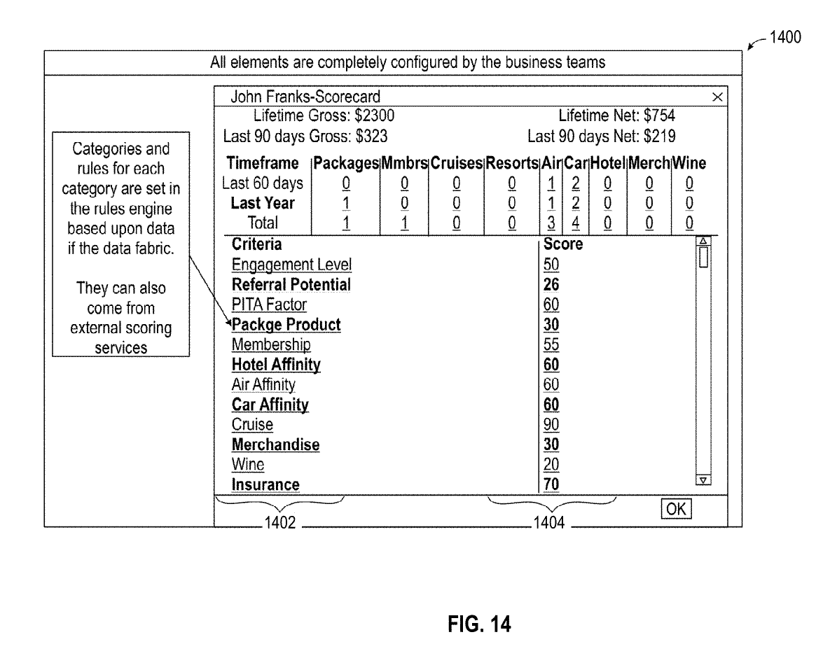

Referring now to FIG. 14, an exemplary scorecard 1400 depicts various scoring criteria 1402 and corresponding values 1404 assigned by the system. These values may be algorithmically weighted and used to quantify the member's FLV. The criteria may include factors relating to the member's affinity for various product categories, such as cruise, hotel, air, as well as additional factors which seek to quantify non-monetary member attributes which tend to predict the member's future purchasing potential.

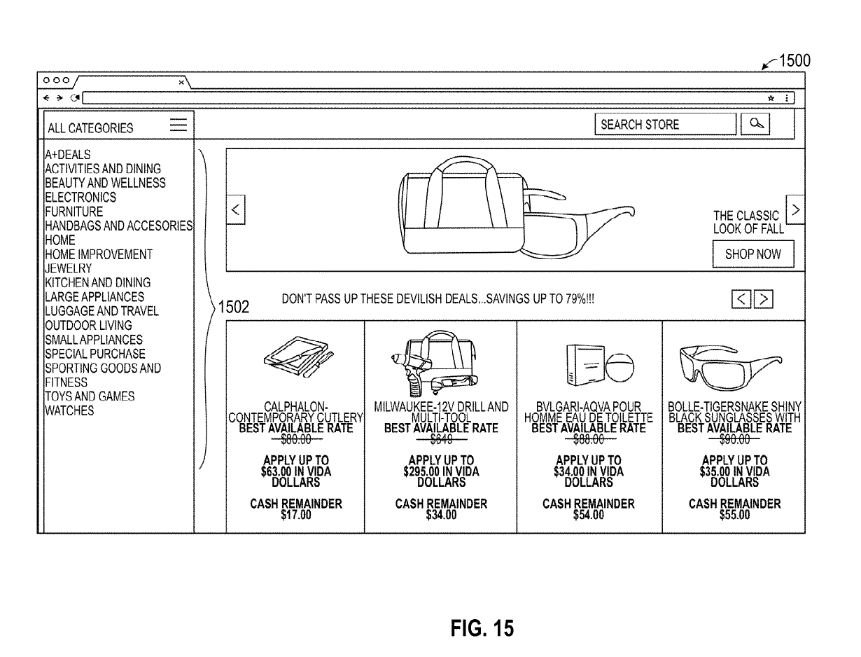

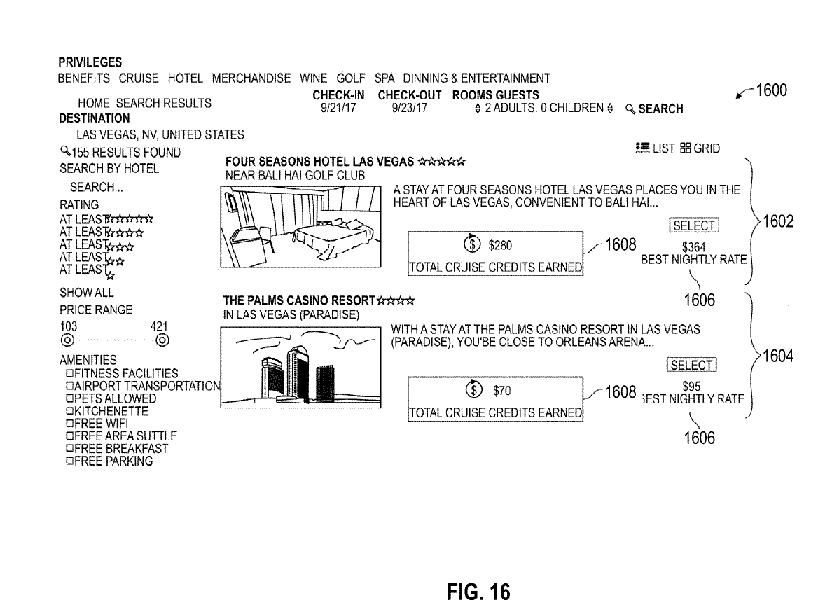

FIG. 15 is a screen shot of a landing page 1500 for an exemplary cruise rewards program, depicting any number of categories 1502 of travel related and non-travel related products, services, and merchandise. Clicking on a hotel category and searching for Las Vegas hotels for a particular date range reveals the search results shown in FIG. 16. That is, FIG. 16 is a screen shot showing a search results page 1600 including a plurality of available rooms 1602, 1604, each depicting the best nightly rate 1606 (generally analogous to a FMV rate) and earned cruise credits 1608. As discussed above, the earned cruise credits are generally analogous to the net margin available to the system. In the cruise rewards use case, however, a substantial portion of the available margin is used to fund the earned credits, as opposed to being used to reduce FMV to MPR (i.e., buy down from the retail price) as described above.

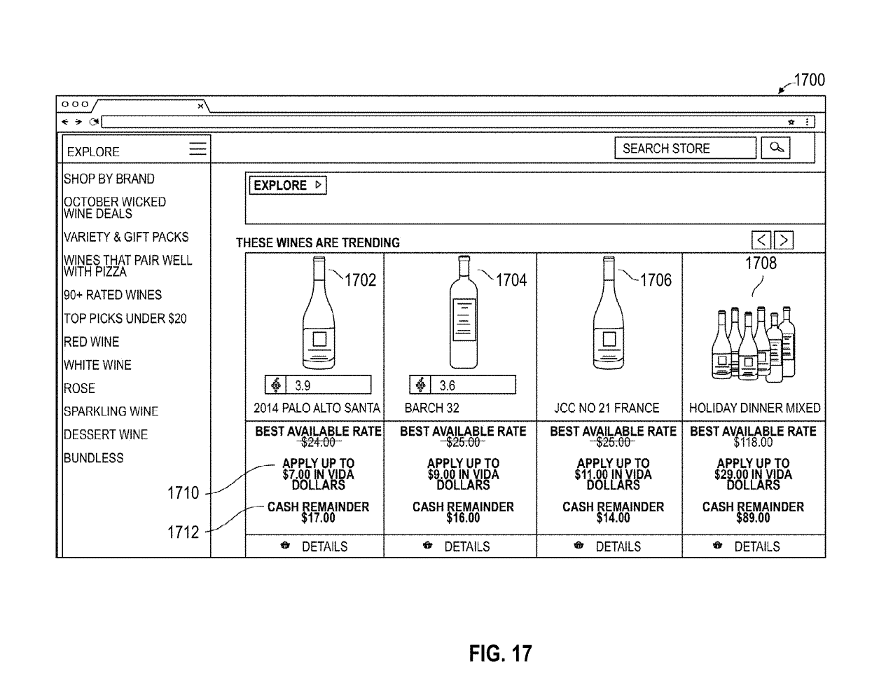

FIG. 17 is a screen shot showing an exemplary search results page 1700 within a cruise rewards platform, illustrating a plurality of product options 1702-1708 (wine in the example shown) responsive to the search query, each depicting an FMV 1710 and an earned cruise credits field 1712.

A system is provided for processing a purchase transaction for a product selected by a member, the system comprising: a gross margin module configured to calculate a gross margin based on a fair market value (FMV),a net margin module configured to calculate a net margin based on the gross margin, overhead costs, and transactional expenses, a lifetime value module configured to calculate a lifetime value associated with the member, and a yield engine configured to calculate a member preferred rate (MPR) based on the net margin and the lifetime value.

A method is also provided for tracking a future lifetime value (FLV) parameter associated with a member of a rewards program, the method comprising the steps of: establishing an initial negative value for the member based on the member's estimated acquisition cost, detecting a non-monetary even performed by the member, assigning a first value to the non-monetary event, and updating the member's FLV to reflect both the initial negative value and the first value.

A method is provided for calculating a gross margin associated with a purchased product, and allocating the gross margin between a consumer and a web based shopping portal. The method includes the steps of: receiving a product definition and a personal credential from the user, using the personal credential to determine a user class and a unique lifetime value associated with the user, defining a first group of retail sites and a mutually exclusive second group of retail sites, retrieving respective price quotes for the defined product from the first and second groups of retail sites, associating one of the first and second groups with the user based on the user class, calculating a fair market value (FMV) based on the price quotes retrieved from the associated group, determining a cost value of the defined product, calculating a MPR based on the FMV, the cost value, and the lifetime value, displaying the FMV, the retail price, and a subset of the associated group, and prompting the user to purchase the defined product at the retail price.

A system for processing a travel-related sequence of user interactions includes: an operational intelligence engine configured to store the travel-related sequence of user interactions, a reconciliation engine configured to query the operational intelligence engine to determine a set of actions performed in conjunction with the sequence of user interactions, and an audit module configured to receive the set of actions from the reconciliation engine, verify the actions, and store the verified actions in an immutable distributed ledger.

In one embodiment, the audit module achieves consensus with respect to the immutable distributed ledger with at least one external supplier system.

In one embodiment, the audit module is configured to create a smart contract including the set of actions, determine whether all terms of the smart contract have been fulfilled, and attempt fulfillment of any unfulfilled terms of the smart contract.

In one embodiment, the audit module is configured to provide a notification when the attempt at fulfillment is unsuccessful.

In one embodiment, the travel-related sequence of user interactions includes user search results, user payment verification, and booking information.

In one embodiment, the system includes a yield engine configured to calculate a member preferred rate (MPR) based on a net margin and a lifetime value of the user, the yield engine including a machine learning model trained via supervised learning based on a user-modifiable yield matrix and a corresponding rule set.

A system for processing a purchase transaction for a product selected by a member includes: a gross margin module configured to calculate a gross margin based on a fair market value (FMV), a net margin module configured to calculate a net margin based on the gross margin, overhead costs, and transactional expenses, a lifetime value module configured to calculate a lifetime value associated with the member, and a yield engine configured to calculate a member preferred rate (MPR) based on the net margin and the lifetime value, wherein the yield engine includes a machine learning model trained via supervised learning based on an operator-modifiable yield matrix and a corresponding rule set. In one embodiment, the machine learning model is implemented as a neural network model.

In one embodiment, the operator-modifiable yield matrix and corresponding rule set are implemented as a web-based user interface.

In one embodiment, the user interface allows the operator to select category tags associated with values in the yield matrix.

In one embodiment, the category tags include at least margin percent, margin amount, and yield.

A method for processing a travel-related sequence of user interactions generally includes: storing, within an operational intelligence engine, the travel-related sequence of user interactions, querying the operational intelligence engine to determine a set of actions performed in conjunction with the sequence of user interactions, and receiving, with an audit module, the set of actions from the reconciliation engine, verifying the actions, and storing the verified actions in an immutable distributed ledger.

In one embodiment the method further includes achieving consensus with respect to the immutable distributed ledger with at least one external supplier system.

In one embodiment, the method includes creating a smart contract including the set of actions, determining whether all terms of the smart contract have been fulfilled, and attempting fulfillment of any unfulfilled terms of the smart contract.

In one embodiment, the method further includes providing a notification when the attempt at fulfillment is unsuccessful.

In one embodiment, the travel-related sequence of user interactions includes user search results, user payment verification, and booking information.

In one embodiment, the method includes providing a yield engine including a machine learning model trained via supervised learning, wherein the supervised learning is based on an operator-modifiable yield matrix and a corresponding rule set, and calculating, with a yield engine, a member preferred rate (MPR) based on a net margin and a lifetime value of the user.

In one embodiment, the operator-modifiable yield matrix and corresponding rule set are implemented as a web-based user interface.

In one embodiment, the user interface allows the operator to select category tags associated with values in the yield matrix.

In one embodiment, the category tags include at least: margin percent, margin amount, and yield.

As used herein, the word “exemplary” means “serving as an example, instance, or illustration.” Any implementation described herein as “exemplary” is not necessarily to be construed as preferred or advantageous over other implementations, nor is it intended to be construed as a model that must be literally duplicated.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

1. A system for processing a sequence of travel-related user interactions, the system comprising:
an operational intelligence engine configured to store the sequence of travel-related user interactions;
a reconciliation engine configured to query the operational intelligence engine to determine a set of actions performed in conjunction with the sequence of user interactions; and
an audit module configured to receive the set of actions from the reconciliation engine, verify the actions, and store the verified actions in an immutable distributed ledger.

2. The system of claim 1, wherein the audit module achieves consensus with respect to the immutable distributed ledger with at least one external supplier system.

3. The system of claim 1, wherein the audit module is configured to:
create a smart contract including the set of actions;
identify any unfulfilled terms of the smart contract; and
attempt to satisfy the unfulfilled terms of the smart contract.

4. The system of claim 1, wherein the audit module is configured to transmit a notification to an administrator of the unfulfilled terms.

5. The system of claim 1, wherein the travel-related sequence of user interactions includes user search results, user payment verification, and booking information.

6. The system of claim 1, further including a yield engine configured to calculate a member preferred rate (MPR) based on a net margin and a lifetime value of the user, the yield engine including a machine learning model trained via supervised learning based on a user-modifiable yield matrix and a corresponding rule set.

7. A system for processing a purchase transaction for a product selected by a member, comprising:
a gross margin module configured to calculate a gross margin based on a fair market value (FMV);
a net margin module configured to calculate a net margin based on the gross margin, overhead costs, and transactional expenses;
a lifetime value module configured to calculate a lifetime value associated with the member; and
a yield engine configured to calculate a member preferred rate (MPR) based on the net margin and the lifetime value, wherein the yield engine includes a machine learning model trained via supervised learning based on an operator-modifiable yield matrix and a corresponding rule set.

8. The system of claim 7, wherein the machine learning model is implemented as a neural network model.

9. The system of claim 7, wherein the operator-modifiable yield matrix and corresponding rule set are implemented as a web-based user interface.

10. The system of claim 9, wherein the user interface allows the operator to select category tags associated with values in the yield matrix.

11. The system of claim 10, wherein the category tags include at least margin percent, margin amount, and yield.

12. A method for processing a travel-related sequence of user interactions, the method comprising:
storing, within an operational intelligence engine, the travel-related sequence of user interactions;
querying the operational intelligence engine to determine a set of actions performed in conjunction with the sequence of user interactions;
receiving, with an audit module, the set of actions from the reconciliation engine;
verifying the actions; and
storing the verified actions in an immutable distributed ledger.

13. The method of claim 12, further including achieving consensus with respect to the immutable distributed ledger with at least one external supplier system.

14. The method of claim 12, further including:
creating a smart contract including the set of actions;
determining whether all terms of the smart contract have been fulfilled; and
attempting fulfillment of any unfulfilled terms of the smart contract.

15. The method of claim 14, further including providing a notification when the attempt at fulfillment is unsuccessful.

16. The method of claim 12, wherein the travel-related sequence of user interactions includes user search results, user payment verification, and booking information.

17. The method of claim 12, further including the steps of:
providing a yield engine including a machine learning model trained via supervised learning, wherein the supervised learning is based on an operator-modifiable yield matrix and a corresponding rule set; and
calculating, with a yield engine, a member preferred rate (MPR) based on a net margin and a lifetime value of the user.

18. The method of claim 17, wherein the operator-modifiable yield matrix and corresponding rule set are implemented as a web-based user interface.

19. The method of claim 18, wherein the user interface allows the operator to select category tags associated with values in the yield matrix.

20. The method of claim 19, wherein the category tags include at least margin percent, margin amount, and yield.
